(19) United States
(12) Patent Application Publication
(10) Pub. No.: US 2010/0302999 A1
(43) Pub. Date: Dec. 2, 2010

(54) METHOD AND APPARATUS FOR RELAYING IN WIRELESS NETWORKS

(76) Inventors: Yan Hui, San Diego, CA (US); Edwin Park, San Diego, CA (US)

Correspondence Address: Patentique PLLC, P.O. Box 50368, Bellevue, WA, 98015, US

(21) Appl. No.: 12/779,883

(22) Filed: May 13, 2010

Related U.S. Application Data
(60) Provisional application No. 61/182,497, filed on May 29, 2009.

(51) Int. Cl. H04B 7/14

(52) U.S. Cl. 370/315

(57) ABSTRACT

Conventional approach for relay nodes in a wireless system only uses one type of relay in part of or entire system and it does not change dynamically. The present invention enables asymmetric replay for a number of aspects in a network.

### FIELD OF THE INVENTION

This non-provisional application claims benefit to U.S. Provisional Application No. 61/182,497, filed May 29, 2009, which is hereby incorporated by reference in its entirety as if fully set forth.

The present invention relates to methods and apparatuses for relaying in wireless networks.

### BACKGROUND OF THE INVENTION

In a wireless network, base station communicates with the terminals. Examples of a base stations can be cellular base station (e.g. macrocell, microcell, picocell, and femtocell), relay nodes, repeaters, access points, or similar. Examples of terminals can be mobile station (or User Equipment, i.e. UE), CPE, data cards, relay nodes or any device with a wireless connection.

Relay nodes in a wireless system may be applied with different purposes. In rural areas the relay node aims to improve wireless coverage. In an urban hot spot, the relay node aims to achieve higher spectrum efficiency and higher capacity. Also, in urban dead zones, the relay aims to resolve the coverage problem in holes.

Relay systems can be characterized into several types.

L1 (Layer 1) relay: L1 relay nodes are also known as repeaters. An L1 relay node amplifies and forward the received signal from the source in the physical layer without decoding the user data. The simplest form of an L1 relay node is an RF repeater.

L2 (Layer 2) relay: L2 relay nodes decode and forward the data including decoding and forwarding user-plane data. By decoding and recoding the data blocks from the source and forwarding to the target in layer 2, no noise is forwarded. Link adaptation may be performed individually for each hop to more efficiently utilize the resources. In addition, RRM (Radio Resource Manager) can be implemented in relay node which may provide benefits in terms of higher throughput and larger coverage. Since L2 consists of multiple sublayers, there are different possible decoding-and-forwarding points. In 3GPP air-interface standard context, for example, L2 relay can happen at MAC PDU level, or RLC PDU level, or PDCP PDU level.

L3 (Layer 3) relay: L3 relay nodes forward the user-plane data packets at the IP layer.

Even though the relay is with respect to user data, appropriate control-plan data may have to be decoded and/or forwarded, and some new messages maybe needed.

Relay nodes can play an important role in network deployment. However, relay node adds noise/interference and delay to the system. To achieve required network performance and cost optimization, different types of relay nodes maybe needed. For example, the uplink (UL) and downlink (DL) channels are different for FDD systems due to different carrier frequency for UL and DL, and they are time-varying with different fading characteristics. As a result, there is a need to have asymmetric relay in a system in order to optimize the system performance.

### SUMMARY OF THE INVENTION

An object of the present invention is to provide an improved methods and apparatuses for relaying in wireless networks

The invention allows for relay nodes to be asymmetric in a number of aspects in a network.

In accordance with an aspect of the present invention there is provided a wireless relay comprising: a first direction having a first level; and a second direction having a second level; the first level and second levels differing with respect to at least one predetermined characteristic.

In accordance with another aspect of the present invention there is provided a wireless network comprising: a first relay for a first direction having a first level; and a second relay for a second direction having a second level; the first level and second levels differing with respect to at least one predetermined characteristic.

### BRIEF DESCRIPTION OF THE DRAWINGS

The present invention will be further understood from the following detailed description with reference to the drawings in which:

FIG. 1 illustrates an a known base station communicating with a user terminal (e.g. UE);

FIG. 2 illustrates an example of base station communicating with a terminal via a relay node;

FIG. 3 shows an illustrative example of a typical wireless communication system;

FIG. 4 shows an illustrative example of a stack used in the wireless communication system of FIG. 3;

FIG. 5 shows an illustrative example of a wireless system with a relay node;

FIG. 6 shows an illustrative example of a wireless communication system in accordance with an embodiment of the present invention;

FIG. 7 shows an illustrative example of a wireless communication system in accordance with another embodiment of the present invention;

FIG. 8 shows an illustrative example of a wireless communication system in accordance with a further embodiment of the present invention;

FIG. 9 shows an illustrative example of a wireless communication system in accordance with a yet further embodiment of the present invention; and

FIG. 10 shows an illustrative example of a wireless communication system in accordance with a still further embodiment of the present invention.

### DETAILED DESCRIPTION OF THE PREFERRED EMBODIMENT

After reading this description, it will become apparent to one skilled in the art how to implement the invention in various alternative embodiments and alternative applications. Although various embodiments of the present invention are described herein, it is understood that these embodiments are presented by way of example only, and not limiting. As such, this detailed description of various alternative embodiments should not be construed to limit the scope or breadth of the present invention.

Relay nodes are devices that relay information from the base station to the terminal. One reason wireless systems deploy relay nodes is to reduce cost for the same coverage or other metric. It can also improve the capacity and performance of a network. Furthermore, the location may not be amenable to have a viable backhaul. In this case, one way to extend the network is to employ a relay.

Currently the types of relay nodes are symmetric and it does not change over time. The invention allows for the variety of the relay node to be asymmetric from a number of aspects, for example, from the uplink and the downlink. Furthermore, data traffic and channels are not constant over time, therefore, there is a need for relay not only asymmetric but also changing dynamically over time based on the conditions.

In a wireless system choosing the different variety of relay nodes have different implications: cost, noise, capacity, delay, etc. One relay node type may be better in one environment than another. Furthermore, different devices, applications, and channels, may not be symmetric to others. Therefore, a relay node for one device, application, channel or link may not be optimal for another device, application, channel, or link. The invention allows for different relay types on the channel, the link, application and more generally a resource.

Furthermore, the wireless system is not static. The channel conditions may change. The device and application mix may change. The invention allows for the relay type to accommodate the change in the wireless system. The invention allows for the communication of the relay node to determine which variety relay node for the link, channel, or the resource. One means is an in-band or out-of-band message. One means of the communication is an indicator bit or an indicator channel.

It should be noted that different termination point within a layer can also create asymmetric in the relay. For example, different termination sub-layers in L2 relay is also considered as asymmetric relay in the following context.

According to one embodiment of this invention, the UL and DL of one or more of the connections in a system have different types of relay nodes. For example, the uplink uses L2 or L3 relay and the downlink uses L1 relay in partial or the entire network.

Another example is that DL is a broadcast type of traffic using L1 relay (i.e. mobile TV). The uplink can be a L2 or L3 relay node for individual user to send on-demand data and the users can have different air interfaces as long as the relay node can decode and process the information, and then re-encode them into the air-interface that base station can process.

According to one embodiment of this invention, different relay types can be used for different air-interface channels. The air-interface channels can refer to physical channels, transport channels, logical channels, or any other gradation. One example is to use L1 relay node for control channels or for a fast feedback channel (e.g. HARQ ACK/NACK) and L2/L3 relay node for the user data channels. In another example, the system can use an L1 relay node for the broadcast, paging, pilot channels, etc. and L2/L3 for the user data channel.

According to another embodiment of this invention, different relay types can be used based on different bandwidth and QoS requirements for different applications or data traffic. For example, VoIP traffic can use L1 relay to reduce latency, and other high rate data traffic can use L2 or L3 relay for better throughput.

According to another embodiment of this invention, different relay types can be used for different services, users, or applications.

According to another embodiment of this invention, a system can use different relay types to overcome or compensate asymmetric network issues. For example, the IP backhaul may be asymmetric; therefore, an asymmetric relay system may be implemented to mach the TCP/IP ACK/NACK with the TCP/IP data.

According to another embodiment of this invention, a system can use different relay types based on wireless channel conditions. This can be assigned statically or be determined dynamically. The decisions can be made based on measurements or feedback from the terminal, base stations, other relay nodes, or other devices sensing the network.

According to one embodiment of this invention, different portion of radio resources can use different types of relays. For example, in an OFDM system, the time-frequency plane can be partitioned into different zones so that each zone has its own type of relay. In a CDMA system, the CDMA code channels can be partitioned into different zones such that each zone has its own type of relay.

According to another embodiment of this invention, the location and size of the zones or the types of relay for each zone can be changed dynamically as part of the radio resource management.

According to another embodiment of this invention, the relay type can be different in different hops or node of a relay path.

According to another embodiment of this invention, the relay type can be different in different frequencies, sectors of the relay node.

According to one embodiment of this invention, the relay type can be changed over time. Furthermore, the relay type can be changed dynamically. The change can occur as a result of inputs from the relay or other elements of the system.

According to another embodiment of this invention, the relay can employ different multiple access schemes (e.g. TDD, FDD) for different links involved. For example, the links can be the link from the relay node to another base station (or another relay node) and the link from the relay node to the terminal.

According to one embodiment of this invention, the relay type can be requested or granted by base station, relay node or UEs via messages. More specifically, an indicator bit or an indicator channel can be used so that the relay node can decode this information to decide what type of relay it should be for specific link, channel, traffic, radio resource, or time period.

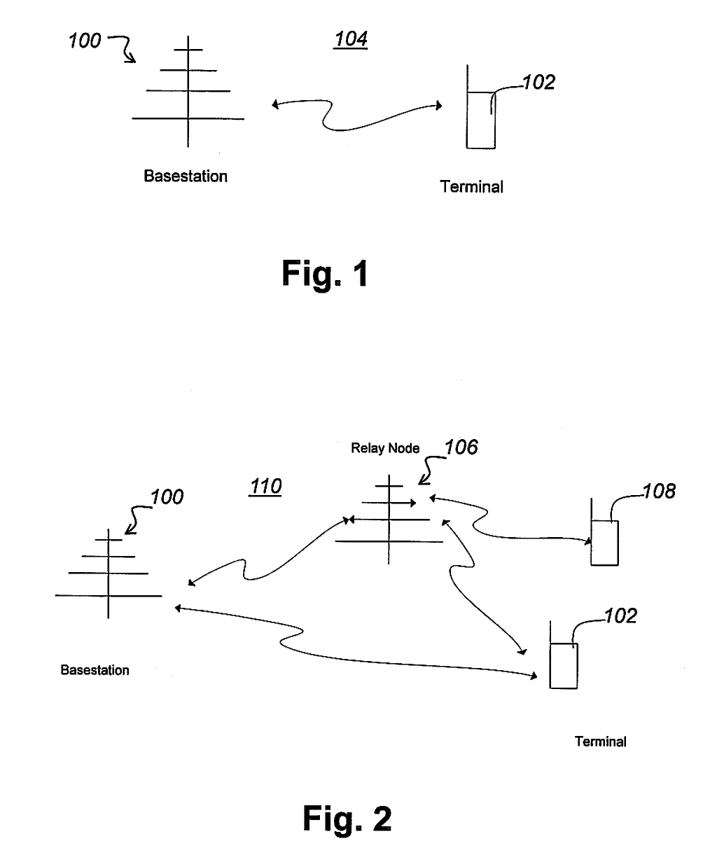

Referring to FIG. 1 there is illustrated a known base station communicating with a user terminal (e.g. UE). The base station 100 communicates in the uplink and downlink to the terminal 102. The system 104 can include multiple base stations. The system can include multiple terminals.

Referring to FIG. 2 there is illustrated an example of base station communicating with a terminal via a relay node. Multiple relay nodes 106 may exist between the base station 100 and the terminal 102, 108. The base station 100 and the terminal 102, 108 can also communicate with each other directly while using the relay node(s) 106. Current relay nodes relay both the uplink and the downlink. An example of a relay node is a simple RF amplifier. The system 110 can include multiple base stations, relay nodes, or terminals.

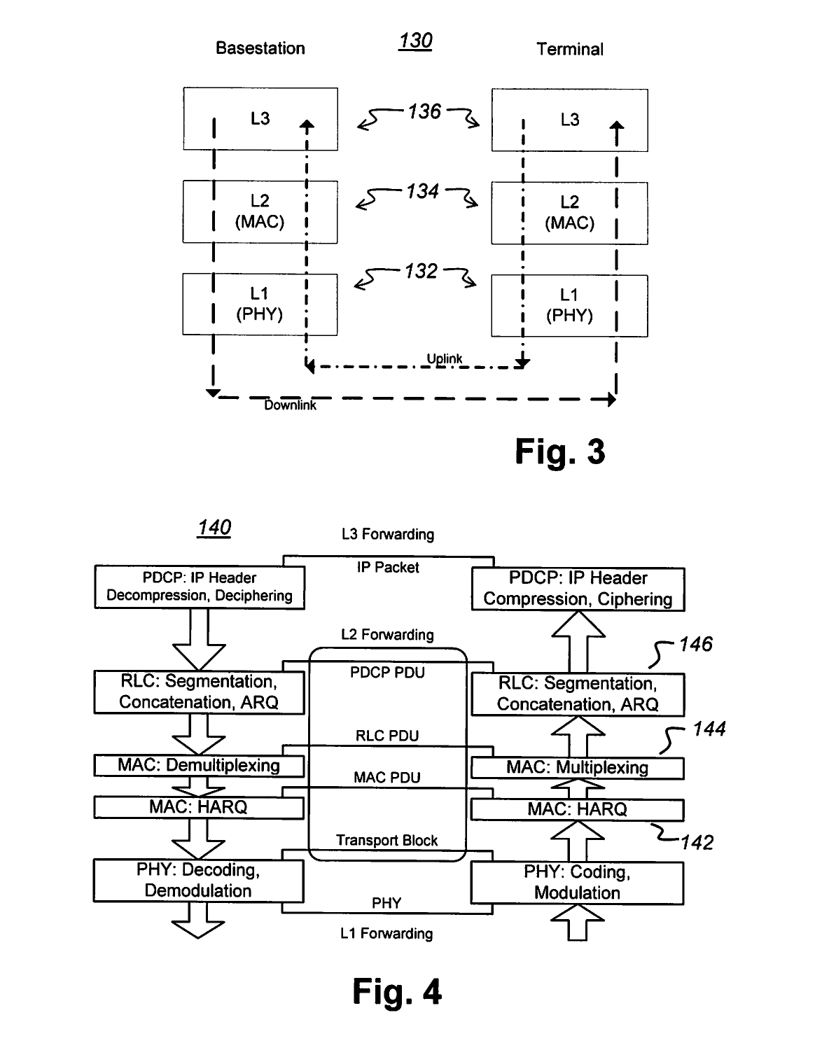

Referring to FIG. 3 there is shown an illustrative example of a typical wireless communication system. The protocol stack 130 is shown as three illustrative layers (L1-132, L2-134, L3-136), the actual number and graduation of the protocol stack can be different. This figure is an example of the protocol stack used in a system shown in FIG. 1

Referring to FIG. 4 there is shown an illustrative example of a stack used in the wireless communication system of FIG. 3. The protocol stack 140 is shown with the corresponding illustrative layers, the actual number and gradation of the stack can be different. This figure is an illustrative example of different layer divisions 142, 144 and 146 possible in a relay node (e.g. L1, L2, L3 Forwarding).

Referring to FIG. 5 there is shown an illustrative example of a wireless system with a relay node. The wireless system 150 is shown as three illustrative layers (L1, L2, L3), the actual number and graduation of the stack can be different. Though shown with one relay node 106, the system 150 may include multiple hops. The base station 100 and the terminal 102 can also communicate with each other directly while using the relay nodes. Though shown with a L1 relay node 106, a relay node of any type may be used. This figure is an example of the stack used in a system shown in FIG. 2.

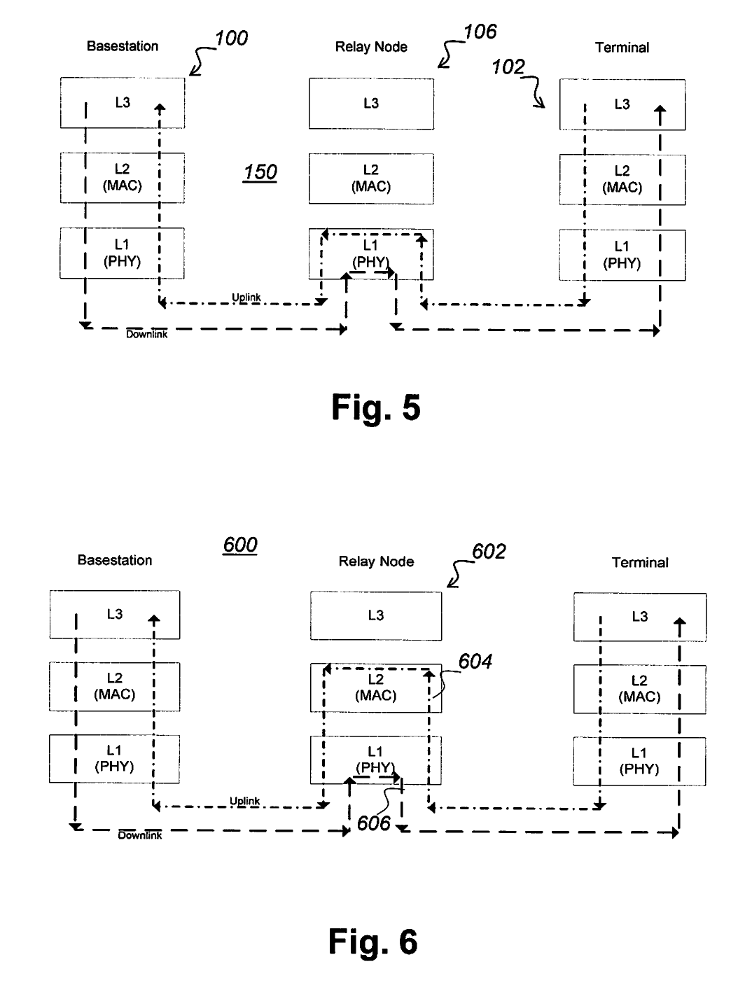

Referring to FIG. 6 there is shown an illustrative example of a wireless communication system 600 in accordance with an embodiment of the present invention. The system is similar to that is described in FIG. 2. However the system 600 employs a relay node 602 embodying the invention where the uplink 604 is in L2 while the downlink 606 is L1.

Although shown as three illustrative layers, the actual number and graduation of the stack can be different. Although shown with one relay node, the system 600 may include multiple hops. Although shown with an L2 uplink and L1 downlink, the system 600 can be any permutation of the variety of uplink and downlink.

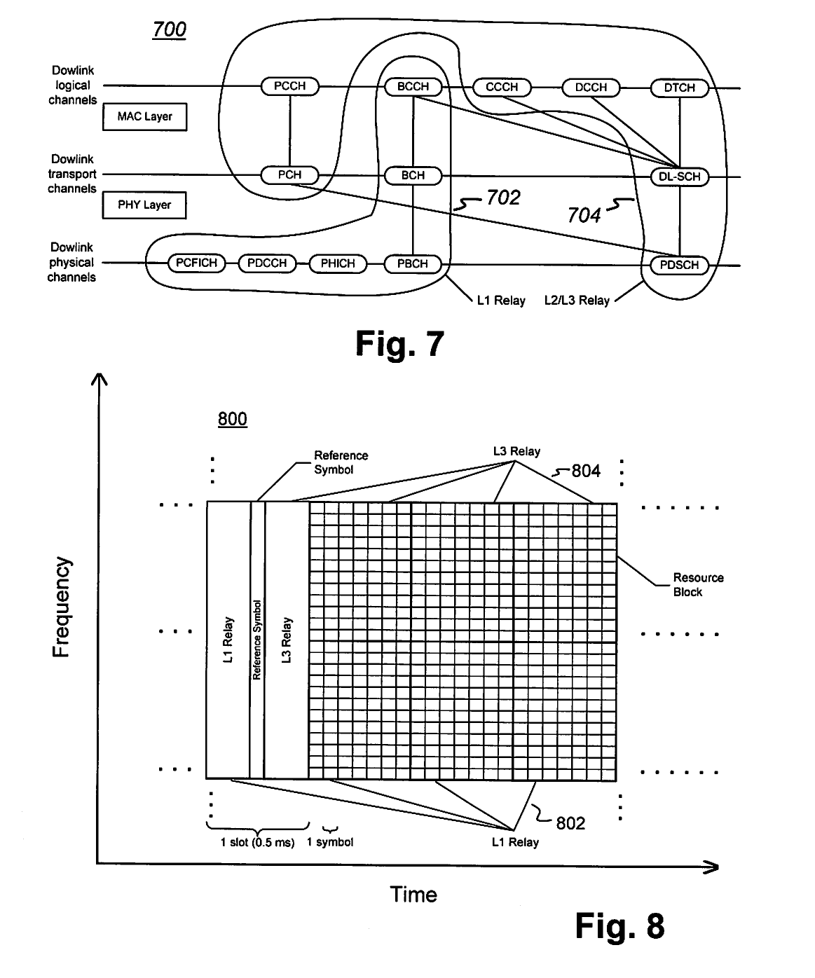

Referring to FIG. 7 there is shown an illustrative example of a wireless communication system in accordance with another embodiment of the present invention. The system 700 includes different channels that utilize different relay technologies. In this example certain channels 702 use L1 relay type while others 704 use L2/L3. Although the figure only shows a downlink channel, the system 700 can also have the invention employed on the uplink channel. Furthermore, additional channels (e.g. multicast channels) can be added in the system. Though the figure shows the mapping of the different channels, the invention can be employed at any level and with any mapping. Furthermore, channels can be applied to multiple types of relays variety. Though the present embodiment of the invention shows the relay nodes of two varieties, the invention can in implemented in systems having multiple varieties simultaneously.

Referring to FIG. 8 there is shown an illustrative example of a wireless communication system in accordance with a further embodiment of the present invention. The system 800 of FIG. 8 includes different radio resources that utilize different relay technologies. In this example, certain resource blocks 802 use L1 relay while others 804 use L3 relay. Although the figure shows resource blocks in an OFDM system, the resource allocated can be different (e.g. code space for CDMA systems). Although the figure shows the allocation of the resources separated over time, the resources can be separated by frequency or a combination of both or a system that is not allocated by another method or a method that changes over time. Although the figure shows the different relay technology on the uplink channel, the downlink channel can equally be used and even at the same time.

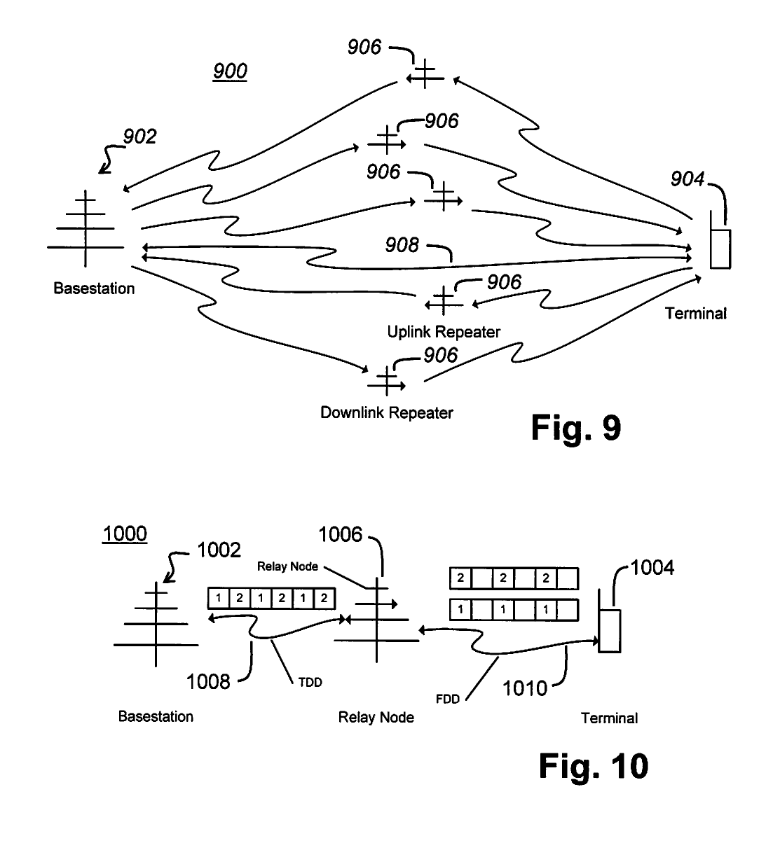

Referring to FIG. 9 there is shown an illustrative example of a wireless communication system in accordance with a yet further embodiment of the present invention. The system 900 includes base station(s) 902, terminal(s) 904 and relay nodes 906. The relay nodes 906 are of the type that is either uplink or downlink. The present embodiment of the invention allows for different type of relay type on the uplink and downlink. The absence of the relaying on one of the link is a possible type. Although the figure shows only one base station and one terminal in the system 900, multiple base stations 902 or terminal 904 can be used in the system 900. Although the figure shows multiple relays 906 in both the uplink and downlink in the system, the system may consist of one or even zero in either direction. For illustration, a direct path 908 from the base station 902 to the terminal 904 is shown. Furthermore, system 900 may also have a base station communicating directly with the terminal. A bi-directional relay (with or without embodying the invention) may also be employed in the system.

Referring to FIG. 10 there is shown an illustrative example of a wireless communication system in accordance with a still further embodiment of the present invention. The system 1000 includes a base station(s) 1002, terminal(s) 1004, and relay node(s) 1006. The relay nodes 1006 employ a different access scheme 1008 for its link to the base station (or other relay nodes) and 1001 for the link for the terminal. In this Figure, the link 1008 from the base station (or other relay node) to the relay node is of the TDD access scheme. In this Figure, the link 1010 from the relay node to the terminal is the FDD access scheme. Although the Figure shows this allocation, any combination of access scheme is possible.

Those of skill will appreciate that the various illustrative logical blocks, modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular system and design constraints imposed on the overall system. Skilled persons can implement the described functionality in varying ways for each particular system, but such implementation decisions should not be interpreted as causing a departure from the scope of the invention. In addition, the grouping of functions within a module, block or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), a application system specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter, which is broadly contemplated by the present invention. It is further understood that the scope of the present invention fully encompasses other embodiments that may become obvious to those skilled in the art.

Numerous modifications, variations and adaptations may be made to the particular embodiments described above without departing from the scope patent disclosure, which is defined in the claims.

What is claimed is:

1. A wireless relay comprising:
a first direction having a first level; and
a second direction having a second level;
the first level and second levels differing with respect to at least one predetermined characteristic.

2. A wireless relay as claimed in claim 1 wherein the predetermined characteristic comprises protocol stack layers.

3. A wireless relay as claimed in claim 1 wherein the predetermined characteristic comprises termination sub layers.

4. A wireless relay as claimed in claim 1 wherein the predetermined characteristic comprises channel type.

5. A wireless relay as claimed in claim I wherein the predetermined characteristic comprises physical channel.

6. A wireless relay as claimed in claim 1 wherein the predetermined characteristic comprises logical channel.

7. A wireless relay as claimed in claim 1 wherein the predetermined characteristic comprises transport channel.

8. A wireless relay as claimed in claim 1 wherein the predetermined characteristic comprises radio resources.

9. A wireless relay as claimed in claim 1 wherein the predetermined characteristic comprises access scheme.

10. A wireless relay as claimed in claim 1 wherein the first and second directions are the same direction.

11. A wireless relay as claimed in claim 1 wherein the first and second directions are opposite directions.

12. A wireless relay as claimed in claim 1 wherein the predetermined characteristic is time variant.

13. A wireless relay as claimed in claim 1 wherein the predetermined characteristic is time variant statistically.

14. A wireless relay as claimed in claim 1 wherein the predetermined characteristic is time variant dynamically.

15. A wireless relay as claimed in claim 1 wherein the predetermined characteristic is time variant depending upon channel conditions.

16. A wireless relay as claimed in claim 1 wherein one of the first and second levels is a zero level.

17. A wireless network comprising:
a first relay for a first direction having a first level; and
a second relay for a second direction having a second level;
the first level and second levels differing with respect to at least one predetermined characteristic.

18. A wireless network as claimed in claim 17 wherein the predetermined characteristic comprises protocol stack layers.

19. A wireless network as claimed in claim 17 wherein the predetermined characteristic comprises termination sub layers.

20. A wireless network as claimed in claim 17 wherein the predetermined characteristic comprises channel type.

21. A wireless relay as claimed in claim 17 wherein the predetermined characteristic comprises physical channel.

22. A wireless relay as claimed in claim 17 wherein the predetermined characteristic comprises logical channel.

23. A wireless relay as claimed in claim 17 wherein the predetermined characteristic comprises transport channel.

24. A wireless network as claimed in claim 17 wherein the predetermined characteristic comprises radio resources.

25. A wireless network as claimed in claim 17 wherein the predetermined characteristic comprises access scheme.

26. A wireless network as claimed in claim 17 wherein the first and second directions are the same direction.

27. A wireless network as claimed in claim 17 wherein the first and second directions are opposite directions.

28. A wireless network as claimed in claim 17 wherein the first and second relays comprise a single relay.

29. A wireless network as claimed in claim 14 wherein the first and second relays comprise different sectors of a single relay.

30. A wireless network as claimed in claim 14 wherein the predetermined characteristic is time variant.

31. A wireless network as claimed in claim 17 wherein the predetermined characteristic is time variant statistically.

32. A wireless network as claimed in claim 17 wherein the predetermined characteristic is time variant dynamically.

33. A wireless network as claimed in claim 17 wherein the predetermined characteristic is time variant depending upon channel conditions.

34. A wireless network as claimed in claim 17 wherein the predetermined characteristic is an OFDM zone in time- frequency plane.

35. A wireless network as claimed in claim 17 wherein the predetermined characteristic is a code in CDMA.

36. A wireless network as claimed in claim 17 wherein one of the first and second levels is a zero level.

37. A wireless network as claimed in claim 17 wherein first and second directions are first and second relay hops.

38. A wireless network as claimed in claim 17 wherein first and second levels are for first and second users.

39. A wireless network as claimed in claim 17 wherein first and second levels are for first and second applications.

40. A wireless network as claimed in claim 17 wherein wireless network is a cellular network.

41. A wireless network as claimed in claim 17 wherein the predetermined characteristic is time variant as a function of a message.

42. A wireless network as claimed in claim 17 wherein the predetermined characteristic is time variant as a function of a message on an indicator channel.

43. A wireless network as claimed in claim 17 wherein the predetermined characteristic is time variant as a function of a message sent in band.

44. A wireless network as claimed in claim 17 wherein the predetermined characteristic is time variant as a function of a message sent out of band.

45. A wireless network as claimed in claim 17 wherein the predetermined characteristic is time variant via feedback from a network element.

46. A wireless network as claimed in claim 17 wherein the predetermined characteristic is time variant via feedback from a terminal.

47. A wireless network as claimed in claim 17 wherein the predetermined characteristic is time variant via feedback from a base station.

48. A wireless network as claimed in claim 17 wherein the predetermined characteristic is time variant via feedback from another relay.
